(19) United States
(12) Patent Application Publication
(10) Pub. No.: US 2005/0243117 A1
(43) Pub. Date: Nov. 3, 2005

(54) Divergence filters on quadrilateral grids for ink-jet simulations

(76) Inventor: Jiun-Der Yu, Sunnyvale, CA (US)

Correspondence Address: EPSON RESEARCH AND DEVELOPMENT INC;INTELLECTUAL PROPERTY DEPT, 150 RIVER OAKS PARKWAY, SUITE 225, SAN JOSE, CA, 95134, US

(21) Appl. No.: 10/834,896

(22) Filed: Apr. 28, 2004

(51) Int. Cl. B41J 29/38

(52) U.S. Cl. 347/19

(57) ABSTRACT

The development and use of divergence filters on quadrilateral grids in connection with a finite-difference-based ink-jet simulation model improves the stability of the code in the model, and allows the use of larger time step size and hence reduces the CPU time. The filters are employed after the finite element projection in each time step and function as additional finite difference projections that are enforced at edge mid-points and at cell centers. The improved model and accompanying algorithm enable more precise control of ink droplet size and shape.

### RELATED APPLICATION DATA

This application is related to application Ser. No. 10/390,239, filed on Mar. 14, 2003 and entitled “Coupled Quadrilateral Grid Level Set Scheme for Piezoelectric Ink-Jet Simulation.” This application is also related to application Ser. Nos. 10/729,637; 10/652,386; 10/105,138, respectively filed on Dec. 5, 2003; Aug. 29, 2003; and Mar. 22, 2002 and respectively entitled “Selectively Reduced Bi-Cubic Interpolation for Ink-Jet Simulations on Quadrilateral Grids,” “Consistent Back Pressure for Piezoelectric Ink-Jet Simulation,” and “A Slipping Contact Line Model and the Mass-Conservative Level Set Implementation for Ink- Jet Simulation.” The disclosures of these related applications are incorporated herein by reference.

### BACKGROUND OF THE INVENTION

1. Field of the Invention

The present invention relates to improvements in a model and accompanying algorithm to simulate and analyze ink ejection from a piezoelectric print head. In such a model that includes a quadrilateral grid for finite-difference-based ink-jet simulation, this invention employs divergence filters on the quadrilateral grids. The simulation model may be embodied in software, hardware or combination thereof and may be implemented on a computer or other processor-controlled device.

2. Description of the Related Art

This invention improves on the models and algorithms for simulating ink ejection from a piezoelectric print head as set forth in above-identified applications. The models and algorithms employ the level set method to accurately capture the ink-air interface in simulations. The level set method accurately accounts for surface tension aspects of fluid flow, especially when the ink droplet is smaller than 5 pico liters. Such capability is important since ejecting ultra small ink droplets is essential for any photo quality ink-jet printer today. Since there is a mathematical relation between the level set and the interface curvature, and hence the surface tension, the level set method excels whenever surface tension is important.

Because solving the level set equation by finite element analysis usually results in a serious mass conservation problem, finite difference analysis is usually the best choice among numerical schemes to be used with the level set method. In a typical rectangular grid the wall of the narrowing section of the modeled nozzle is not parallel to any coordinate axis. Thus, the discretized computational domain can not faithfully fit the real nozzle wall. A body-fitted quadrilateral grid does not have that problem.

This invention provides further improvements to the existing quadrilateral-based ink ejection simulation models and algorithms set forth in the above-identified applications.

### OBJECT AND SUMMARY OF THE INVENTION

Object of the Invention

It is therefore an object of the present invention to provide a model and accompanying algorithm to simulate and analyze ink ejection that incorporates divergence filters on the quadrilateral grid to improve the stability of the code, and allows the use of larger time step size and hence reduces CPU time.

Summary of the Invention

According to one aspect of this invention, a method for simulating and analyzing ejection of a first fluid from a channel is provided. An interface is between the first and second fluids as the first fluid flows through the channel. The method comprises simulating the ejection of the first fluid from the channel using a level set projection algorithm that comprises (1) creating a quadrilateral grid in a physical space, (2) calculating a transformation, preferably a transformation matrix, for transforming equations derived with respect to the quadrilateral grid for application to a uniform square grid in a computational space, the uniform square grid having a plurality of cells, (3) solving equations governing the first and second fluids including solving a velocity predictor equation to obtain a predictor velocity of the first fluid, (4) projecting the predictor velocity into a divergence-free space to obtain pressure and velocity fields for the first fluid, and (5) applying one or more divergence filters to reduce divergence at edges or centers of cells.

Preferably, the first fluid is ink, the second fluid is air, and the channel is representative of an ink-jet nozzle designed to be part of a piezoelectric ink-jet head.

In step (4), the velocity field obtained is preferably an incompressible velocity field.

The divergence filter(s) may comprise an edge filter applied at cell edges and/or a center filter applied at cell centers. Preferably, two edge filters are used, including a first edge filter applied at mid-points of each cell edge of a first orientation, and a second edge filter applied at mid-points of each cell edge of a second orientation.

Preferably, an iterative linear solver is used to solve linear systems resulting from application of the divergence filter(s), with 3 or less iterations being performed by the iterative linear solver to solve the linear systems.

In another aspect, the invention involves an apparatus for simulating and analyzing ejection of a first fluid, e.g., ink, from a channel, there being an interface between the first and second fluids as the first fluid flows through the channel. The apparatus includes various modules or components that are configured to perform the functions described above in connection with method. These modules may be implemented in software, hardware or combination thereof. A hardware module may be realized with an application specific integrated circuit (ASIC), digital signal processing circuitry, etc.

In accordance with further aspects of the invention, any of the above-described methods or steps thereof may be embodied in a program of instructions (e.g., software) which may be stored on, or conveyed to, a computer or other processor-controlled device for execution. Alternatively, any of the methods or steps thereof may be implemented using functionally equivalent hardware or a combination of software and hardware.

Other objects and attainments together with a fuller understanding of the invention will become apparent and appreciated by referring to the following description and claims taken in conjunction with the accompanying drawings.

### BRIEF DESCRIPTION OF THE DRAWINGS

In the drawings wherein like reference symbols refer to like parts:

FIG. 1 is a cross-sectional view of an ink-jet nozzle;

FIG. 2 schematically illustrates a coordinate transformation from a rectangular computational space to a physical axi-symmetric space;

FIG. 3 illustrates a boundary-fitted quadrilateral grid for ink-jet simulation;

FIG. 4 illustrates a uniform square grid in the computational space;

FIG. 5 illustrates the direction and magnitude of derivatives X_{ξ} and X_{η} in the physical space;

FIG. 6 illustrates the position of a discrete q function and velocity field on a uniform 1×1 grid in the computational space, for a Y-edge filter;

FIG. 7 illustrates the position of a discrete q function and velocity field on a uniform 1×1 grid in the computational space, for an X-edge filter;

FIG. 8 illustrates the position of a discrete q function and velocity field on the uniform 1×1 grid in the computational space, for a cell center filter;

FIG. 9 is a flow chart illustrating the numerical algorithm according to embodiments of the invention;

FIG. 10 is a graphical representation of the inflow pressure for the ejection of highly viscous ink with respect to time;

FIG. 11 is a sequence of images illustrating the ejection of a high viscosity ink droplet from an ink-jet nozzle; and

FIG. 12 is a block diagram illustrating an exemplary system which may be used to implement aspects of the present invention.

### DESCRIPTION OF THE PREFERRED EMBODIMENTS

I. Introduction

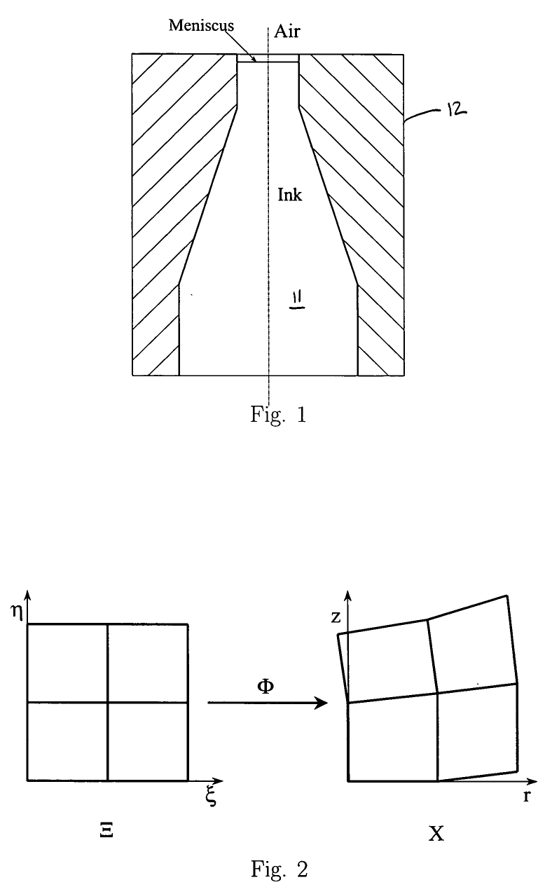

This invention is directed to the use of divergence filters on a quadrilateral grid that is used in simulating ink ejection from a channel, such as a channel 11 in an ink-jet nozzle 12 as shown in FIG. 1. The figure also shows the meniscus and ink-air interface.

The invention is motivated by the unusually small time step when the ejection of high viscosity ink droplets is simulated. The small time step is more than 50% smaller than the viscosity time step constraint given in equation (33), which is listed in the Appendix along with all other numbered equations referenced in the following discussion. By doing numerical experiments, the inventor has found that, when the ink viscosity is high, the regular level set projection scheme on quadrilateral grids, as was presented in related application Ser. No. 10/390,239, can no longer guarantee that the velocity field is approximately incompressible (i.e., approximately divergence-free) everywhere. The divergence is reasonably small at grid points, but is usually very large at the mid-points of cell edges and at cell centers near the ink-air interface.

As was explained in related application Ser. No. 10/390,239, the velocity and level set are located at cell centers, and the pressure is at grid points. The FEM projection is constructed such that the incompressibility condition ∇·u=0 is enforced at grid points (instead of everywhere in the solution domain). So it is beneficial to modify the Level Set projection scheme to solve the problem and improve the code stability.

A direct solution to this task is to construct extra projections that enforce the incompressibility at the mid point of cell edges and at cell centers. But it takes a lot of CPU time if it is necessary to solve the linear systems resulting from these extra projections. My idea is to exploit the local nature (usually near the ink-air interface) of the divergence field and only solve the linear systems to a reasonable accuracy. Since these extra projections are solved approximately, they are called divergence filters. These filters are employed after the finite element projection in each time step.

In this invention, the governing equations to solve in ink-jet simulations are described in section II. The numerical algorithm, i.e., the Level Set projection scheme on quadrilateral grids, as was disclosed in related application Ser. No. 10/390,239, is reviewed in section III. The construction of the cell edge and cell center filters, as well as the iterative method used to solve the resulting linear systems, is explained in section IV. A description of the algorithm and filters, with reference to a flow chart, is given in section V. A simulation example is given in section VI to demonstrate the effect of this invention.

II. Equations of Motion

A. Governing Equations

The governing equations for two-phase flows include the continuity equation (1) and the Navier-Stokes equations (2). In these equations, the rate of deformation tensor and the fluid velocity are respectively defined in equations (3).

$$\frac{ⅅ}{ⅅ t} = \frac{\partial }{\partial t} + ( u \cdot ∇ )$$

is the Lagrangian time derivative, ρ the relative density, p the pressure, μ the relative dynamic viscosity, σ the surface tension coefficient, κ the curvature, δ the Dirac delta function, and φ the level set.

A level set formulation is used to define the interface between the two fluids, e.g., ink and air, and hence the relative density, relative dynamic viscosity, and curvature are all defined in terms of the level set φ as in equation (4).

Here, the level set function φ is initialized as the signed distance to the interface, i.e., the level set value is the shortest distance to the interface on the liquid side and is the negative of the shortest distance on the air side. The unit normal on the interface, drawn from fluid 2 (e.g., air) into fluid 1 (e.g., ink), and the curvature of the interface can be expressed in terms of φ as in equation (5).

To make the governing equations dimensionless, the following definitions, as set forth in (6), are chosen. The primed quantities are dimensionless, and L, U, ρ₁, μ₁ are respectively the characteristic length, characteristic velocity, density of fluid 1, and dynamic viscosity of fluid 1. The characteristic velocity and characteristic length can be arbitrarily chosen, as they do not influence the result of simulation.

Substituting the relationships of (6) into equations (1) and (2), and dropping the primes, yields equations (7) and (8), where the relative density ratio ρ(φ), relative viscosity ratio μ(φ), Reynolds number Re, and Weber number We are defined by equations (9).

Since the interface moves with the fluid, the evolution of the level set is governed by equation (10).

Since equations (5), (7) and (8) are expressed in terms of the vector notation, they assume the same form in Cartesian coordinates and axi-symmetric coordinates.

B. Governing Equations on Quadrilateral Grid

Consider a continuous transformation Φ which maps rectangular grid points in a rectangular computational space Ξ=(ξ,η) to quadrilateral grid points in physical axi-symmetric space X=(r, z) according to equation (11) and as shown in FIG. 2. The Jacobian and the transformation matrix are defined by equations (12), where g=2πr for the axi-symmetric coordinate system. The transformed convection velocity is defined by equation (13).

According to related application Ser. No. 10/390,239, the governing equations on the quadrilateral grid are as set forth in equation (14) where the viscosity term is given by equation (15).

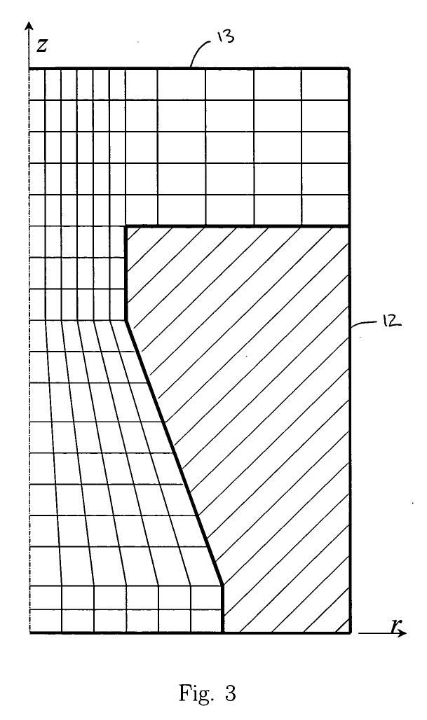

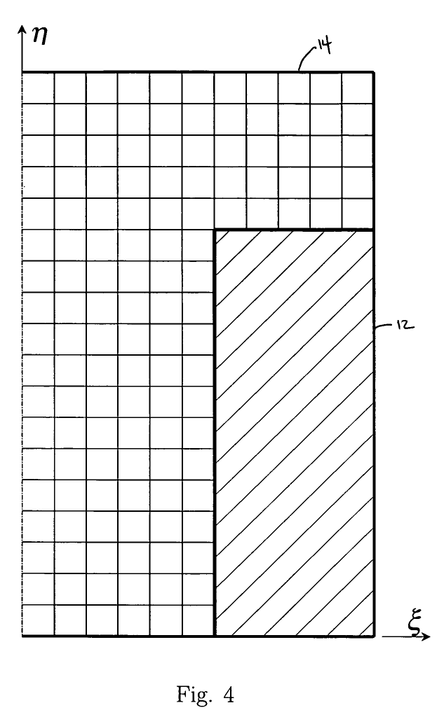

Observe that equations (14) and (15) are derived for a quadrilateral grid in the axi-symmetric coordinate system; however, they can be used for two-dimensional flow problems if the last term in equation (15) is neglected and the substitution in equation (16) is used. Also, equation (15) can be checked by reducing the computational space Ξ=(ξ,η) to the physical space X=(r, z). For this case, the transformation matrix reduces to the identity matrix and the Jacobian to g. Furthermore, it should be noted that ∇_{Ξ} and ∇_{Ξ}· are “matrix operators” while ∇ and ∇· are vector operators. When a vector operator is put in front of a vector quantity, it not only “operates” on the magnitude of the vector quantity but also on the direction. Here, the matrix operators ∇_{Ξ} and ∇_{Ξ}· are applied to scalars or matrices, and hence the “direction” is not relevant. Also, to make the numerical derivative as simple as possible, the corresponding grid in the computational space is 1×1 square. The nozzle 12 and the body-fitted quadrilateral grid (comprised of a plurality of individual grids) 13 in the physical space is shown in FIG. 3, while the nozzle 12 and corresponding square grid 14 in the computational space is shown in FIG. 4.

The derivation of governing equations on a quadrilateral grid is set forth in related application Ser. No. 10/390,239.

C. Boundary Conditions

On solid walls it is assumed that the normal and tangential components of the velocity vanishes, although this assumption must be modified at the triple point. At both inflow and outflow, the formulation of this invention allows either the velocity (17) or the pressure (18) to be prescribed as boundary conditions. In equation (18), n denotes the unit normal to the inflow or outflow boundary. For ink-jet simulations, time-dependent inflow conditions are provided by an equivalent circuit model which mimics the charge-driven mechanism which forces ink from the bath into the nozzle.

D. Contact Models

At the triple point, where air and ink meet at the solid wall, the slipping contact line model as presented in related application Ser. No. 10/105,138 referenced above is used.

E. Equivalent Circuit

In a piezo ink-jet print head, the formation of the ink droplet is controlled by a piezoelectric PZT actuator. Driven by the input voltage, the PZT pushes and then pulls the ink. To numerically simulate an ink-jet print head, a velocity or pressure at nozzle inflow must be specified. However, only the input voltage to the PZT is known. Hence, various appropriate values of nozzle inflow velocity or pressure may be specified by the user before simulation, or such values may be the result of previous measurements taken at different voltages input to PZT.

An analytic tool that may be used to obtain inflow pressures that may be used for simulation of the inkjet print head is an equivalent circuit. The ink flow rate and pressure are first taken as dependent variables. Each component of the ink-jet print head, such as the nozzle, pressure chamber, vibration plate, PZT actuator, and ink cartridge, is expressed in terms of the acoustics inertance, compliance, and acoustics resistance. These acoustics elements are finally transferred to their equivalent inductance, capacitance, and electric resistance to form an equivalent circuit. By solving the equivalent circuit and the flow equations in term, a real ink-jet head can be simulated.

Other suitable methods may also be used to obtain inflow pressure values that relate to the PZT input voltage.

A typical driving voltage pattern and a typical inflow pressure are as shown in related application Ser. No. 10/390,239. The driving voltage is such that the ink is first pulled back, pushed and fired, and then pulled back to get ready for the next discharge. The inflow pressure shown in the above related application reflects the reaction of a typical nozzle-ink channel-PZT-cartridge system to the applied voltage.

III. Numerical Algorithms: Quadrilateral Grid

The numerical algorithm is now formulated on a quadrilateral grid. In the following, the superscript n (or n+1) denotes the time step, i.e., equation (19), and so on.

Given quantities uⁿ, pⁿ, φⁿ, the purpose of the algorithm is to obtain uⁿ⁺¹, pⁿ⁺¹, φⁿ⁺¹ which satisfy the condition of incompressibility. The explicit algorithm described herein is first-order accurate in time and second-order accurate in space.

A. Smearing of the Interface

Because of the numerical difficulty caused by the Dirac delta function and by the abrupt change of ρ and μ across the interface, the Heaviside unit step and Dirac delta functions are replaced with smoothed functions, i.e., to smear the interface a little bit. The Heaviside function is redefined by equation (20). Hence, the smoothed delta function is given in equation (21).

The parameter ε is usually chosen to be proportional to the average size of cells as set forth in equation (22), where Δx is the average size of the quadrilateral cells. Typically, a is between 1.7 and 2.5.

B. Temporal Discretization

B.1. Level Set Update

The level set is updated first by equation (23). The time-centered advection term [\overline{u}·∇_{Ξ}φ]^{n+1/2} is evaluated using an explicit predictor-corrector scheme that requires only the available data at tⁿ. Once φⁿ⁺¹ is obtained, φ^{n+1/2} is computed by equation (24).

B.2. Explicit Algorithm for Navier-Stokes Equations

In previous work, temporal discretization is explicit for the advection term and semi-implicit for the viscosity term. The advantage of the semi-implicity is the second-order accuracy in time. The expense is that one needs to solve an extra non-symmetric linear system in each time step. In this invention, an explicit temporal discretization is applied to the viscosity term to reduce the CPU time, as set forth in equation (25). Using the definition of equation (26), the time-discretized Navier-Stokes equations can be written as set forth in equation (27).

A second-order explicit Godunov scheme is applied for the advection term and the central difference for the viscosity term in equation (26). They will be explained later. It is noticeable that the time-centered level set φ^{n+1/2} and the velocity uⁿ for the evaluation of the (viscosity term)ⁿ is used. The determination of u* needs only field quantities at time step n.

Since the finite-element projection is used, for which the special quadrilateral formulation (27) is unnecessary, the corresponding equation in the physical grid is written as in equation (28).

B.3. Projection for un+¹

To satisfy the incompressibility condition for time step n+1 the divergence operator is applied to both sides of equation (28). Since ∇·uⁿ⁺¹=0, the projection equation (29) is obtained which is elliptic. It reduces to a Poisson's equation if the density ratio ρ(φ^{n+1/2}) is a constant. The following finite element formulation, shown in equation (30) where Γ₁ denotes all the boundary with given inflow or outflow velocity u^{BC}, is used to facilitate implementation. It can be seen by the divergence theory that the implied boundary condition at Γ₁ is as shown in equation (31). It is noticeable that the second term at the right hand side of (30) vanishes if only boundary pressures are given at the inflow and outflow.

After the pressure pⁿ⁺¹ is solved from equation (29), the velocity field uⁿ⁺¹ can be obtained by equation (27).

B.4. Re-Initialization of the Level Set

To correctly capture the interface and accurately calculate the surface tension, the level set needs to be maintained as a signed distance function to the interface. However, if the level set is updated by equation (7), it will not remain as such. Therefore, instead, the simulation is periodically stopped and a new level set function φ is recreated which is the signed distance function, i.e., |∇φ|=1, without changing the zero level set of the original level set function.

A direct and simple method for re-initialization is to first find the interface (the zero level set) using a contour plotter and then recalculate the signed distance from each cell to the interface. Another simple re-initialization choice is to solve the crossing time problem as set forth in equation (32), where F is a given normal velocity. It is noticeable that t′ has been used in equation (32) to emphasize that it is a pseudo time variable and the equation is solved solely for the purpose of re-initialization. With F=1, flow the interface forward and backward in time and calculate the time t′ at which the level set function changes sign for each cell. The crossing times (both positive and negative) are equal to the signed distances. Either of these two simple methods are suitable for use with the present invention. Both have been tried with no noticeable difference in simulation results. An even better re-initialization scheme employing the “selectively reduced bi-cubic interpolation” as disclosed in another related application (Ser. No. 10/729,637) is used in the numerical demonstration in this invention. Such a re-initialization scheme exhibits better mass conservation performance.

C. Constraint on Time Step

Since the time integration scheme is explicit Euler, the time constraint is determined by the Courant Friedrichs Lewy (CFL) condition, surface tension, viscosity, and total acceleration, as shown in equation (33), where h=min(Δr, Δz) and Fⁿ is defined in equation (22).

IV. Divergence Filters

The divergence filters are basically additional finite difference projections executed after the finite element projection. Since the finite element projection basically enforces the condition of incompressibility on grid points, the divergence filters are constructed to enforce the incompressibility at edge mid-points and cell centers. To save CPU time, the linear systems resulting from these additional projections are not solved exactly. Due to the high frequency nature of the divergence field, many iterative methods can solve the linear systems reasonably accurate with only several iterations.

A. Projection Equation

Let u^{e} be the velocity field obtained after the finite element projection. The objective then is to find a function q such that the new velocity field given by equation (34) is incompressible. Hence, by taking the divergence of (34) and requiring that ∇·u=0, yields equation (35). On quadrilateral grids, the projection equation (35) takes the form of equation (36).

The boundary conditions for q are similar to those for the pressure in the regular (finite element) projection. At solid walls, equation (37) holds. At the inflow or outflow, if a boundary pressure p^{BC} is given, equation (38) is used; if a boundary velocity u^{BC} is prescribed, equation (39) is obtained.

All the divergence filters are based on equations (36)-(39). The successive over-relaxation (SOR) method is used to approximately solve the resulting linear systems to obtain the discrete q function. The discrete q is then substituted back into equation (34) to modify the velocity. The only difference among the filters is how to construct the finite difference operator and calculate the divergence at edge centers and cell centers.

B. The Idea of Flux

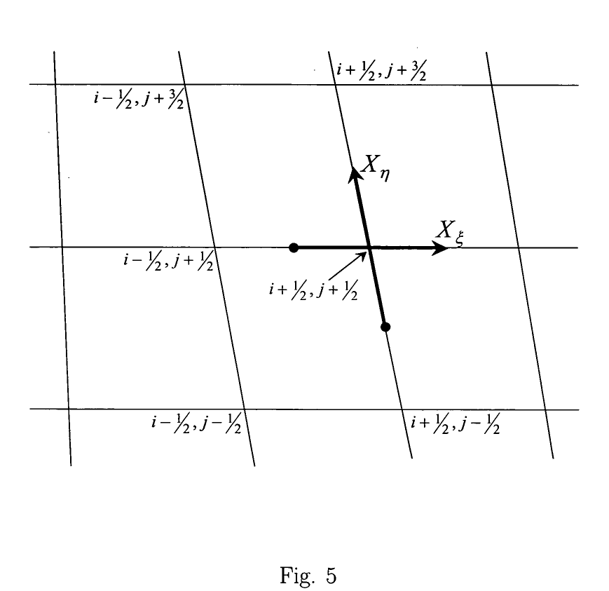

The idea of flux, which is very helpful in the discretization of projection equations, comes from a physical space interpretation of the transformation matrix T. Referring to FIG. 5, if equation (40) is used to define the matrix at the mid point of an X edge, it can be seen that (X_{η})_{i+1/2,j} is tangent to the edge with magnitude equal to the length of the edge. Consequently, the first component of the transformed velocity \overline{u}, i.e. g(z_{η}u−r_{η}v), is actually the velocity flux across the cell edge. Similarly, at a Y edge, (X_{ξ})_{i,j+1/2} is tangent to the edge and the second component of \overline{u}, i.e., g(−z_{ε}u+r_{ε}v), is the velocity flux across the Y edge if equation (41) is used.

Considering the transformed velocities as flux, one can easily calculate the right hand side of (36) because it reduces to the sum of the outgoing velocity flux across the four edges. For the left hand side of (36), the idea of flux suggests that we just have to calculate the flux of the quantity (42) across the edges.

In the following subsections, the idea of flux is not only applied but also the requirements (40) and (41) are relaxed to facilitate the discretization of filters. Having defined the transformation matrix and Jacobian at cell centers, averaging will be used, instead of (40) and (41), to obtain the metric elements in the calculation of the transformed velocity \overline{u}.

C. Y-edge Filter

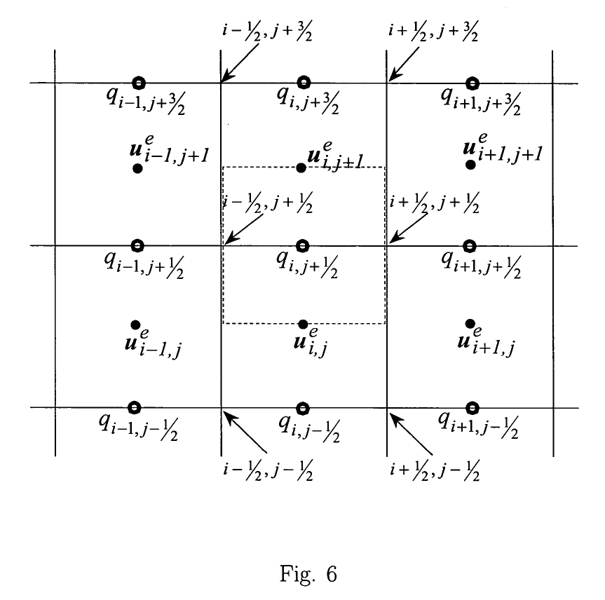

As shown in FIG. 6, for the filter to be enforced at the mid-point of each Y edge, the discrete function q is located at the mid-point of each Y edge. Considering the virtual cell (denoted by dash lines in FIG. 6), the right hand side of equation (36), i.e., the divergence at the mid-point of each Y edge, is calculated using the idea of flux in equation (43), where the four fluxes are given in (44). The finite difference operator for the left hand side of equation (36) is set forth in equation (45), where the four fluxes and α, β, and γ are given by equations (46) and (47), respectively. In these equations, the subscripts denote the position where the value should be evaluated. See, for an example, equation (48). It is noticeable that averaging has been used to obtain the metric elements and Jacobians not located at cell centers.

Boundary conditions can be easily implemented in the above discretizations. For example, if the right edge of the cell shown by dash lines in FIG. 6 is a solid wall, the flux across the edge should be zero. Hence Fᵣ=0 in (43) and QFᵣ=0 in (45). If the horizontal grid line through q_{i-1,j-1/2}, q_{i,j-1/2}, and q_{i+1,j-1/2} is an inflow boundary and the inflow pressure is given, just plug equation (49) in equation (44).

Having illustrated how to use the idea of flux to discretize the projection equation for a Y-edge filter and employ the boundary conditions, the discretized equations for an X-edge filter and a cell center filter will simply be listed to keep the presentation compact.

D. X-edge Filter

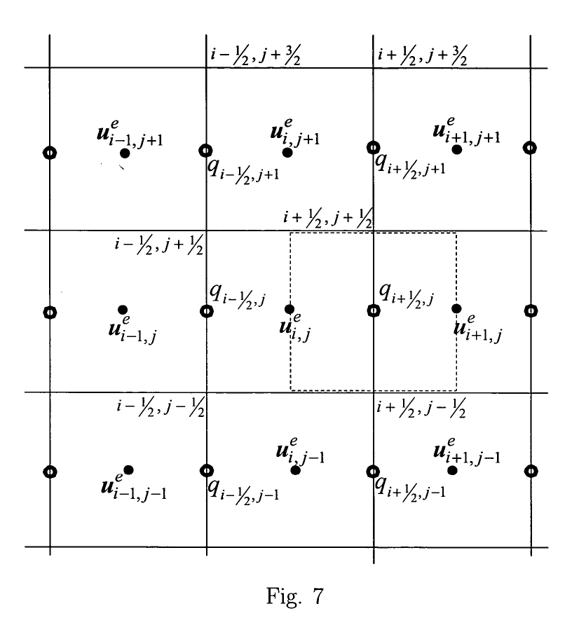

As shown in FIG. 7, for the filter to be enforced at the mid-point of each X edge, the discrete function q is located at the mid-point of each X edge. The right hand side of equation (36), i.e., the divergence of the velocity field at the center of each X edge, is calculated using equation (50). The finite difference operator for the left hand side of equation (36) is set forth in equation (51). In these equations, the subscripts again denote the position where the value should be evaluated.

E. Cell Center Filter

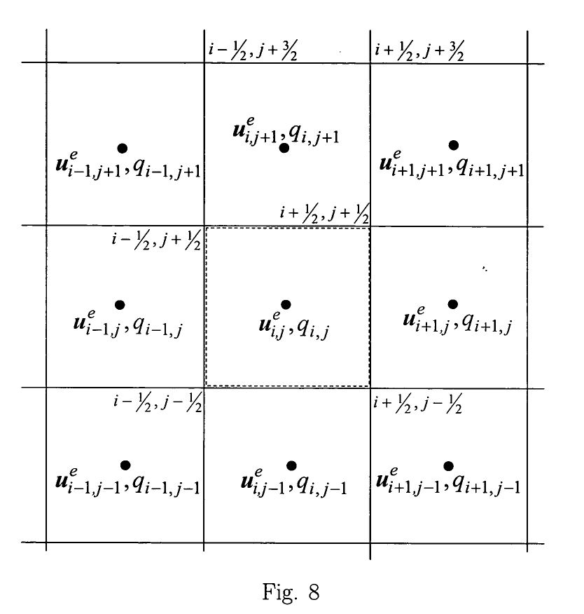

For the filter to be enforced at the center of each cell, the discrete function q is located at the center of each cell, as shown in FIG. 8. The right hand side of equation (36), i.e., the divergence of the velocity field at the center of each cell, is the calculated using equation (52). The finite difference operator for the left hand side of equation (36) is set forth in equation (53). In these equations, the subscripts again denote the position where the value should be evaluated.

F. SOR Solver

Many iterative linear solvers can be used to solve the linear systems resulting from the divergence filters. The Jacobi method, the Gauss-Seidel method, and the successive over-relaxation (SOR) method are just a few examples. According to numerical experiments, the SOR method usually performs best for the filters.

Take the Y-edge filter as an example, the iteration is as given in equations (54), where rhs_{i,j+,1/2} denotes equation (44). Note that the superscript i has been omitted for all q's between the braces. The relaxation parameter must be chosen between 0≦ω≦2. Usually ω=1.7 gives very good performance. The initial value of q_{i,j+1/2} can be obtained by interpolating the pressure at grid points using equation (55). Since the divergence is far from zero only in the vicinity of the interface, just a few iterations are needed to obtain reasonable accuracy for the filters. itₘₐₓ is usually set equal to 3 so that the resolution of linear systems resulting from the filter does not consume a lot of CPU time.

V. The Flowchart

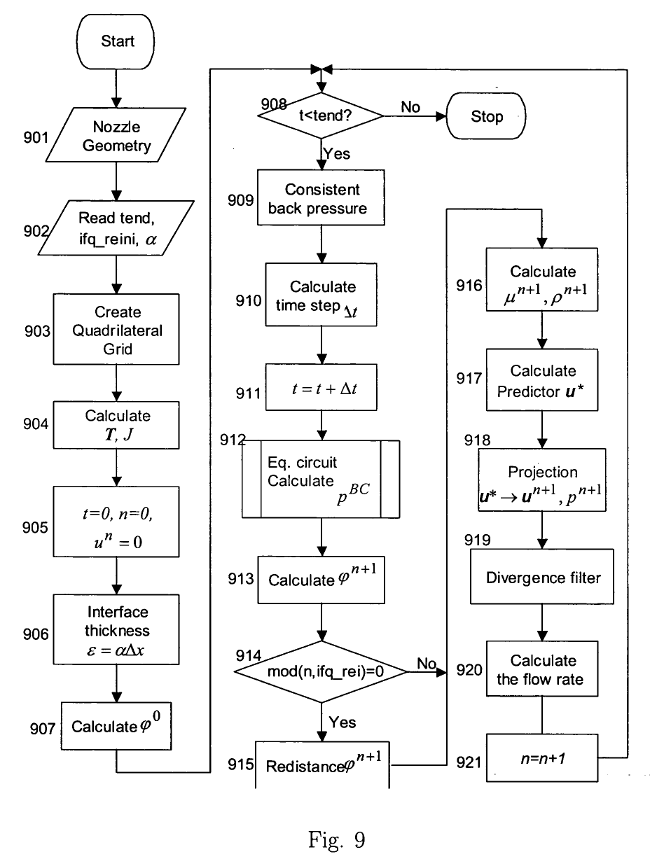

As shown by the flowchart in FIG. 9, the numerical algorithm is basically sequential. The code first reads the nozzle geometry step 901) and also reads control parameters like tend (end time of the simulation), α (the extent of interface smearing), ifq_reini (how often the level set should be re-initialized) (step 902). With the given nozzle geometry, the code creates a body-fitted quadrilateral grid like in FIG. 3 (step 903), and calculates the transformation matrix T and the Jacobian J using equation (12) (step 904). The time and the number of the current time step are set to zero and the initial fluid velocity is set to zero everywhere (step 905). With the given smearing parameter α, the interface thickness is set using equation (22). The level set is then initialized by assuming the initial ink-air interface is flat and using the “selectively reduced bi-cubic interpolation disclosed in related application Ser. No. 10/729,637 (step 907).

Now the time loop starts by checking whether t<tend (step 908). If so, the consistent back pressure is determined as described in related application Ser. No. 10/652,386 (step 909). The time step Δt is then determined by equation (33) to ensure the stability of the code (step 910). The time is updated (step 911). The time step and the ink flow rate (the initial flow rate is zero) are then passed to an equivalent circuit or like analytic tool, which calculates the inflow pressure for the current time step (step 912). After receiving the inflow velocity from the equivalent circuit, the CFD code proceeds to solve the partial differential equations. The level set is first updated using equation (23) (step 913), and, for every ifq_reini time steps, is also re-distanced (steps 914 and 915). The new fluid viscosity and density are calculated using the new level set values (step 916). The velocity predictor equation (26) is then calculated (step 917). The predictor velocity is projected into the divergence-free space to get the new pressure and incompressible velocity fields (step 918). The divergence filters are employed to reduce the divergence at cell edges and cell centers (step 919). The last things to do in the loop are calculating the ink flow rate (step 920) and updating the number of the time step (step 921).

VI. Effect of Filters

As an example of ink-jet simulation using the selectively reduced bi-cubic interpolation for level set re-initialization, consider a small nozzle as shown in FIG. 1 equipped with high viscosity ink. The diameter is, for example, 8 microns at the opening and 13.5 microns at the bottom. In the illustrated embodiment, the length of the nozzle opening portion (i.e., where the diameter is 8 microns) is 5 microns, the length of tapered section is 10 microns, and the length of the bottom portion is 1.5 microns.

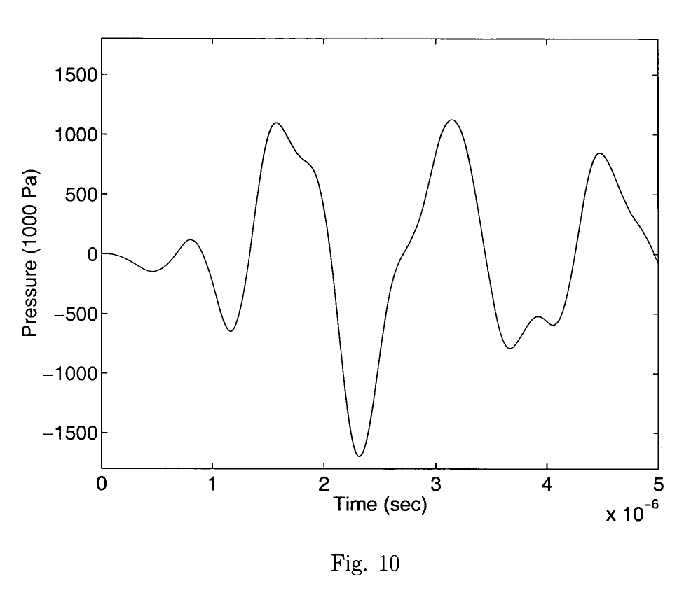

The inflow pressure is given by an equivalent circuit which simulates the effect of the ink cartridge, supply channel, vibration plate, PZT actuator, applied voltage, and the ink inside the channel and cartridge. In this example, the inflow pressure is as shown in FIG. 10, and the outflow pressure at the top of the solution domain is set to zero. The consistent back pressure at the top of the solution domain is calculated as described in related application Ser. No. 10/652,386.

In this example, the solution domain was chosen to be {(r, z)|0≦r≦8.4 μm, 0≦z≦80 μm}. The advancing and receding critical contact angles are 70° and 20° respectively. The initial meniscus is assumed to be flat and 0.5 microns under the nozzle opening.

For the purpose of normalization, the nozzle opening diameter (8 microns) is selected to be the length scale and 6 m/s is selected to be the velocity scale. The normalized solution domain is hence {(r, z)|0≦r≦1.05 μm, 0≦z≦10 μm}. Since the density, viscosity, and surface tension of ink are approximately as given in equations (50), the non-dimensional parameters of equations (51) are obtained. A 32×336 quadrilateral mesh is used in the simulations.

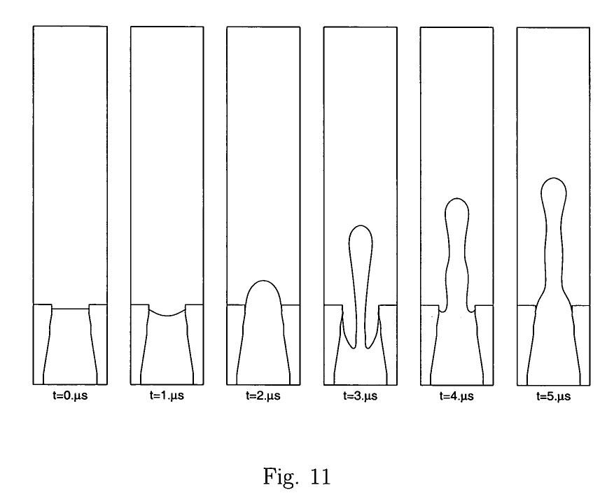

For simulations using the divergence filters, a maximum dimensionless time step Δt=0.0007 can be used. The simulation results to t=5 μs are plotted in FIG. 11. On a workstation with a Windows® operating system and dual 2.8 GHz Xeon processors, the simulation (without parallel computation) took 1661 seconds to finish. The same simulation results can be obtained without employing divergence filters; however, the initial time step can not be larger than 0.00035. The following table compares the code performance with and without the filters.

| | With Filters | No Filters |
|---|---|---|
| CPU time (seconds) | 1661 | 2853. |
| Max. initial time step | 0.0007 | 0.00037 |
| No. of time steps | 5400 | 10144 |
| Average step size | 0.0006945 | 0.0003697 |
| Average CPU time per | 0.3076 | 0.2813 |
| time step | | |

As can be seen from the table, employing divergence filters almost doubles the average time step size. Because the filters take some CPU time, each time step takes approximately 10% longer to finish. However, employing the filters advantageously increases the feasible (stable) time step size and reduces the CPU time needed for simulation.

VII. Implementations and Effects

Using divergence filters on quadrilateral grids in connection with a finite-difference-based ink-jet simulation model as described above improves the code stability, and allows the use of larger time step size and hence reduces the CPU time. The filters are employed after the finite element projection in each time step. They can be deemed as additional finite difference projections that are enforced at edge mid-points and at cell centers. Because the divergence field is usually local, only a few successively over-relaxation iterations are needed to solve the linear systems to a reasonable degree of accuracy.

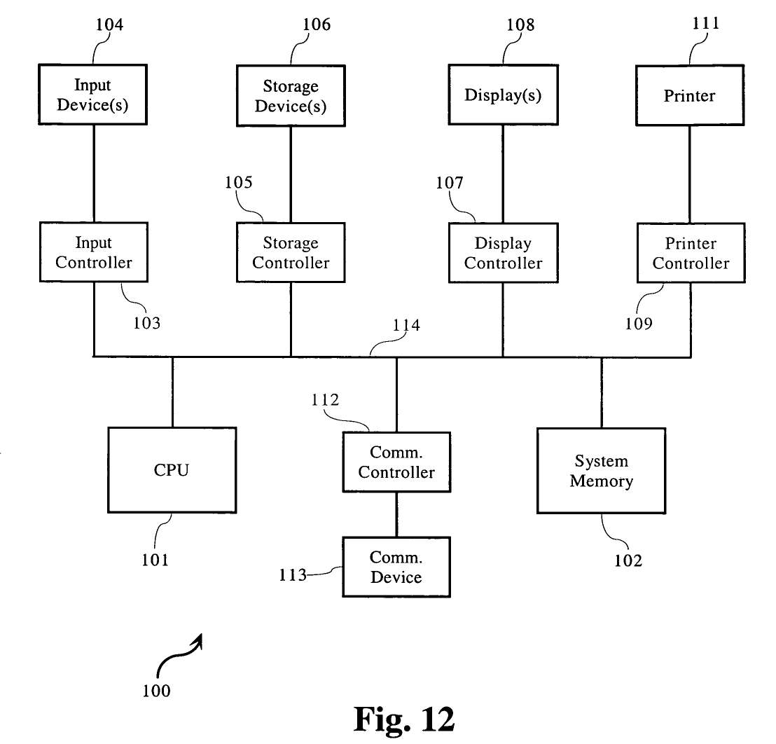

Having described the details of the invention, an exemplary system 100 which may be used to implement one or more aspects of the present invention will now be described with reference to FIG. 12. As illustrated in FIG. 12, the system includes a central processing unit (CPU) 101 that provides computing resources and controls the computer. CPU 101 may be implemented with a microprocessor or the like, and may also include a graphics processor and/or a floating point coprocessor for mathematical computations. System 100 further includes system memory 102 which may be in the form of random-access memory (RAM) and read-only memory (ROM).

A number of controllers and peripheral devices are also provided, as shown in FIG. 12. Input controller 103 represents an interface to various input devices 104, such as a keyboard, mouse or stylus. There is also a storage controller 105 that communicates with one or more storage devices 106, each of which includes a storage medium such as magnetic tape or disk, or an optical medium that may be used to record programs of instructions for operating systems and applications which may include embodiments of programs that implement various aspects of the present invention. Storage device(s) 106 may also be used to store processed or data to be processed in accordance with the invention. A display controller 107 provides an interface to a display device 108 which may be any known type of display. The ink flow and ejection simulation of the present invention may be viewed on such a display. A printer controller 109 is also provided for communicating with a printer 111 that may be used to print simulation plots and other results of the simulation. A communications controller 112 interfaces with one or more communication devices 113 which enables system 100 to connect to remote devices through any of a variety of networks including the Internet, a local area network (LAN), a wide area network (WAN), or through any suitable electromagnetic carrier signals including infrared signals.

In the illustrated system, all major system components connect to bus 114 which may represent more than one physical bus. However, various system components may or may not be in physical proximity to one another. For example, input data and/or output data may be remotely transmitted from one physical location to another. Also, programs that implement various aspects of this invention may be accessed from a remote location (e.g., a server) over a network. Such data and/or programs may be conveyed through any of a variety of machine-readable medium including magnetic tape or disk or optical disc, network signals, or any other suitable electromagnetic carrier signals including infrared signals.

The present invention may be conveniently implemented with software. However, alternative implementations are certainly possible, including a hardware and/or a software/hardware implementation. Any hardware-implemented functions may be realized using ASIC(s), digital signal processing circuitry, or the like. Accordingly, the “means” terms in the claims are intended to cover both software and hardware implementations. Similarly, the term “machine-readable medium” as used herein includes software, hardware having a program of instructions hardwired thereon, or combination thereof. With these implementation alternatives in mind, it is to be understood that the figures and accompanying description provide the functional information one skilled in the art would require to write program code (i.e., software) or to fabricate circuits (i.e., hardware) to perform the processing required.

While the invention has been described in conjunction with several specific embodiments, further alternatives, modifications, variations and applications will be apparent to those skilled in the art in light of the foregoing description. Thus, the invention described herein is intended to embrace all such alternatives, modifications, variations and applications as may fall within the spirit and scope of the appended claims.

### Appendix

$$\begin{matrix}∇ \cdot u = 0 , & ( 1 ) \\ ρ ( ϕ ) \frac{ⅅ u}{ⅅ t} = - ∇ p + ∇ \cdot ( 2 μ ( ϕ ) 𝒟 ) - σ κ ( ϕ ) δ ( ϕ ) ∇ ϕ . & ( 2 ) \\ 𝒟 = \frac{1}{2} [ ∇ u + {( ∇ u )}^{T} ] , u = {ue}_{1} + {ve}_{2} , & ( 3 ) \\ ϕ ( x , y , t ) \{ \begin{matrix}< 0 & if ( x , y ) ∈ fluid \#2 ( air ) \\ = 0 & if ( x , y ) ∈ interface \\ > 0 & if ( x , y ) ∈ fluid \#1 ( ink )\end{matrix} . & ( 4 ) \\ n = \frac{∇ ϕ}{\vert ∇ ϕ \vert} {\vert}_{ϕ = 0} , κ = ∇ \cdot ( \frac{∇ ϕ}{\vert ∇ ϕ \vert} ) {\vert}_{ϕ = 0} . & ( 5 ) \\ x = {Lx}^{′} , y = {Ly}^{′} , u = {Uu}^{′} , t = \frac{L}{U} {t}^{′} , \\ p = {ρ}_{1} {U}^{2} {p}^{′} , ρ = {ρ}_{1} {ρ}^{′} , μ = {μ}_{1} {μ}^{′} , & ( 6 ) \\ ∇ \cdot u = 0 , & ( 7 ) \\ \frac{ⅅ u}{ⅅ t} = - \frac{1}{ρ ( ϕ )} ∇ p + \frac{1}{ρ ( ϕ ) Re} ∇ \cdot ( 2 μ ( ϕ ) 𝒟 ) - \frac{1}{ρ ( ϕ ) We} κ ( ϕ ) δ ( ϕ ) ∇ ϕ , & ( 8 ) \\ ρ ( ϕ ) = \{ \begin{matrix}1 & if ϕ \geq 0 \\ {ρ}_{2} / {ρ}_{1} & if ϕ < 0\end{matrix} , μ ( ϕ ) = \{ \begin{matrix}1 & if ϕ \geq 0 \\ {μ}_{2} / {μ}_{1} & if ϕ < 0\end{matrix} , \\ Re = \frac{{ρ}_{1} UL}{{μ}_{1}} , We = \frac{{ρ}_{1} {U}^{2} L}{σ} . & ( 9 ) \\ \frac{\partial ϕ}{\partial t} + u \cdot ∇ ϕ = 0 , & ( 10 ) \\ X = Φ ( Ξ ) , & ( 11 ) \\ J = g det {∇}_{Ξ} Φ = g det ( \begin{matrix}{r}_{ξ} & {r}_{η} \\ {z}_{ξ} & {z}_{η}\end{matrix} ) , T = {g}^{- 1} {J [ {∇}_{Ξ} Φ ]}^{- 1} = ( \begin{matrix}{z}_{η} & - {r}_{η} \\ - {z}_{ξ} & {r}_{ξ}\end{matrix} ) , & ( 12 ) \\ \overline{u} = gTu , & ( 13 ) \\ \frac{\partial u}{\partial t} + {J}^{- 1} ( \overline{u} \cdot {∇}_{Ξ} ) u = - \frac{1}{ρ ( ϕ ) J} {gT}^{T} {∇}_{Ξ} p + ( Viscosity term ) - \frac{1}{Fr} {e}_{z} - \frac{g δ ( ϕ )}{{J}^{2} ρ ( ϕ ) We} {∇}_{Ξ} \cdot ( gT \frac{{T}^{T} {∇}_{Ξ} ϕ}{\vert {T}^{T} {∇}_{Ξ} ϕ \vert} ) ( {T}^{T} {∇}_{Ξ} ϕ ) , \\ {∇}_{Ξ} \cdot \overline{u} = 0 , \frac{\partial ϕ}{\partial t} + {J}^{- 1} \overline{u} \cdot {∇}_{Ξ} ϕ = 0 , & ( 14 ) \\ \frac{1}{ρ ( ϕ ) Re} ∇ \cdot [ 2 μ ( ϕ ) 𝒟 ] = \frac{g}{J ρ ( ϕ ) Re} [ {T}^{T} {∇}_{Ξ} μ ( ϕ ) ] \cdot [ {gJ}^{- 1} {T}^{T} {∇}_{Ξ} u + {( {gJ}^{- 1} {T}^{T} {∇}_{Ξ} u )}^{T} ] + \frac{μ ( ϕ )}{J ρ ( ϕ ) Re} {∇}_{Ξ} \cdot \{ {g}^{2} {J}^{- 1} {TT}^{T} {∇}_{Ξ} u \} + \frac{μ ( ϕ )}{ρ ( ϕ ) Re} ( \begin{matrix}- \frac{μ}{{r}^{2}} \\ 0\end{matrix} ) . & ( 15 ) \\ r \to x , z \to y , g \to 1 , & ( 16 ) \\ u = {u}^{BC} , & ( 17 ) \\ p = {p}^{BC} , \frac{\partial u}{\partial n} = 0 , & ( 18 ) \\ {u}^{n} = u ( t = {t}^{n} ) , & ( 19 ) \\ H ( ϕ ) = \{ \begin{matrix}0 & if ϕ < - ε \\ \frac{1}{2} [ 1 + \frac{ϕ}{ε} + \frac{1}{π} sin ( π ϕ / ε ) ] & if \vert ϕ \vert \leq ε \\ 1 & if ϕ > ε\end{matrix} & ( 20 ) \\ δ ( ϕ ) = \frac{ⅆ H ( ϕ )}{ⅆ ϕ} , & ( 21 ) \\ ε = α Δ x , & ( 22 ) \\ {ϕ}^{n + 1} = {ϕ}^{n} - {\frac{Δ t}{J} [ \overline{u} \cdot {∇}_{Ξ} ϕ ]}^{n + 1 / 2} , & ( 23 ) \\ {ϕ}^{n + 1 / 2} = \frac{1}{2} ( {ϕ}^{n} + {ϕ}^{n + 1} ) , & ( 24 ) \\ \frac{{u}^{n + 1} - {u}^{n}}{Δ t} + {{J}^{- 1} [ ( \overline{u} \cdot {∇}_{Ξ} ) u ]}^{n + 1 / 2} = - \frac{g}{ρ ( {ϕ}^{n + 1 / 2} ) J} {T}^{T} {∇}_{Ξ} {p}^{n + 1} + {( Viscosity term )}^{n} + {( Surface tension )}^{n + 1 / 2} - \frac{1}{Fr} {e}_{2} . & ( 25 ) \\ {u}^{*} = {u}^{n} + Δ t \{ - {{J}^{- 1} [ ( \overline{u} \cdot {∇}_{Ξ} ) u ]}^{n + 1 / 2} + {( Viscosity term )}^{n} {( Surface tension )}^{n + 1 / 2} - \frac{1}{Fr} {e}_{2} \} , & ( 26 ) \\ {u}^{n + 1} = {u}^{*} - \frac{g Δ t}{ρ ( {ϕ}^{n + 1 / 2} ) J} {T}^{T} {∇}_{Ξ} {p}^{n + 1} . & ( 27 ) \\ {u}^{n + 1} = {u}^{*} - \frac{Δ t}{ρ ( {ϕ}^{n + 1 / 2} )} ∇ {p}^{n + 1} . & ( 28 ) \\ ∇ \cdot {u}^{*} = ∇ \cdot ( \frac{Δ t}{ρ ( {ϕ}^{n + 1 / 2} )} ∇ {p}^{n + 1} ) . & ( 29 ) \\ {\int }_{Ω}^{} {u}^{*} \cdot ∇ ψ ⅆ x = {\int }_{Ω}^{} \frac{Δ t}{ρ ( {ϕ}^{n + 1 / 2} )} ∇ {p}^{n + 1} \cdot ∇ ψ ⅆ x + {\int }_{{Γ}_{1}}^{} ψ {u}^{BC} \cdot n ⅆ S , & ( 30 ) \\ \frac{Δ t}{ρ ( {ϕ}^{n + 1 / 2} )} \frac{\partial {p}^{n + 1}}{\partial n} = ( {u}^{*} - {u}^{BC} ) \cdot n , & ( 31 ) \\ {ϕ}_{{t}^{′}} + F \vert ϕ \vert = 0 , & ( 32 ) \\ Δ t < {min}_{i , j} [ \frac{Δ r}{u} , \frac{Δ z}{v} , \sqrt{We \frac{{ρ}_{1} + {ρ}_{2}}{8 π}} {h}^{3 / 2} , \frac{Re}{2} \frac{{ρ}^{n}}{{μ}^{n}} {( \frac{1}{Δ {r}^{2}} + \frac{1}{Δ {z}^{2}} )}^{- 1} , \sqrt{\frac{2 h}{\vert {F}^{n} \vert}} ] , \\ & ( 33 ) \\ u = {u}^{e} - \frac{1}{ρ ( {ϕ}^{n + 1 / 2} )} ∇ q , & ( 34 ) \\ ∇ \cdot ( \frac{1}{ρ ( {ϕ}^{n + 1 / 2} )} ∇ q ) = ∇ \cdot {u}^{e} , & ( 35 ) \\ {∇}_{Ξ} \cdot ( \frac{{g}^{2}}{ρ ( {ϕ}^{n + 1 / 2} ) J} {TT}^{T} {∇}_{Ξ} q ) = {∇}_{Ξ} \cdot {\overline{u}}^{e} , & ( 36 ) \\ \frac{\partial q}{\partial n} = 0 , & ( 37 ) \\ q = Δ {tp}^{BC} ( {t}^{n + 1 / 2} ) , & ( 38 ) \\ \frac{1}{ρ ( {ϕ}^{n + 1 / 2} )} \frac{\partial q}{\partial n} = n \cdot [ {u}^{e} - {u}^{BC} ( {t}^{n + 1 / 2} ) ] , & ( 39 ) \\ {( {X}_{η} )}_{i + 1 / 2 , j} = {X}_{i + 1 / 2 , j + 1 / 2} - {X}_{i + 1 / 2 , j - 1 / 2} , & ( 40 ) \\ {( {X}_{ξ} )}_{i , j + 1 / 2} = {X}_{i + 1 / 2 , j + 1 / 2} - {X}_{i - 1 / 2 , j + 1 / 2} , & ( 41 ) \\ \frac{{g}^{2}}{ρ ( {ϕ}^{n + 1 / 2} ) J} {T}^{T} {∇}_{Ξ} q , & ( 42 ) \\ R . H . S . = {F}_{r} - {F}_{l} + {F}_{u} + {F}_{d} , & ( 43 ) \\ {F}_{r} = \frac{1}{16} \{ {r}_{i + 1 / 2 , j + 1 / 2} [ ( {u}_{i + 1 , j + 1} + {u}_{i , j + 1} + {u}_{i + 1 , j} + {u}_{i , j} ) ( {z}_{η ( i + 1 , j + 1 )} + {z}_{η ( i , j + 1 )} + {z}_{η ( i + 1 , j )} + {z}_{η ( i , j )} ) - ( {v}_{i + 1 , j + 1} + {v}_{i , j + 1} + {v}_{i + 1 , j} + {v}_{i , j} ) ( {r}_{η ( i + 1 , j + 1 )} + {r}_{η ( i , j + 1 )} + {r}_{η ( i + 1 , j )} + {r}_{η ( i , j )} ) ] \} , \\ {F}_{l} = \frac{1}{16} \{ {r}_{i - 1 / 2 , j + 1 / 2} [ ( {u}_{i - 1 , j + 1} + {u}_{i , j + 1} + {u}_{i - 1 , j} + {u}_{i , j} ) ( {z}_{η ( i - 1 , j + 1 )} + {z}_{η ( i , j + 1 )} + {z}_{η ( i - 1 , j )} + {z}_{η ( i , j )} ) - ( {v}_{i + 1 , j + 1} + {v}_{i , j + 1} + {v}_{i + 1 , j} + {v}_{i , j} ) ( {r}_{η ( i - 1 , j + 1 )} + {r}_{η ( i , j + 1 )} + {r}_{η ( i - 1 , j )} + {r}_{η ( i , j )} ) ] \} , \\ \begin{matrix}{F}_{u} = {r}_{i , j + 1} ( {v}_{i , j + 1} {r}_{ξ ( i , j + 1 )} - {u}_{i , j + 1} {z}_{ξ ( i , j + 1 )} ) , \\ {F}_{d} = {r}_{i , j} ( {v}_{i , j} {r}_{ξ ( i , j )} - {u}_{i , j} {z}_{ξ ( i , j )} ) .\end{matrix} & ( 44 ) \\ L . H . S . = {QF}_{r} - {QF}_{l} + {QF}_{u} - {QF}_{d} & ( 45 ) \\ {QF}_{r} = {α}_{i + 1 / 2 , j + 1 / 2} ( {q}_{i + 1 , j + 1 / 2} - {q}_{i , j + 1 / 2} ) + \frac{1}{4} {β}_{i + 1 / 2 , j + 1 / 2} ( {q}_{i + 1 , j + 3 / 2} - {q}_{i + 1 , j - 1 / 2} + {q}_{i , j + 3 / 2} - {q}_{i , j - 1 / 2} ) , \\ {QF}_{l} = {α}_{i - 1 / 2 , j + 1 / 2} ( {q}_{i , j + 1 / 2} - {q}_{i - 1 , j + 1 / 2} ) + \frac{1}{4} {β}_{i - 1 / 2 , j + 1 / 2} ( {q}_{i , j + 3 / 2} - {q}_{i , j - 1 / 2} + {q}_{i - 1 , j + 3 / 2} - {q}_{i - 1 , j - 1 / 2} ) , \\ {QF}_{u} = {γ}_{i , j + 1} ( {q}_{i , j + 3 / 2} - {q}_{i , j + 1 / 2} ) + \frac{1}{4} {β}_{i , j + 1} ( {q}_{i + 1 , j + 3 / 2} - {q}_{i - 1 , j + 3 / 2} + {q}_{i + 1 , j + 1 / 2} - {q}_{i - 1 , j + 1 / 2} ) , \\ {QF}_{d} = {γ}_{i , j} ( {q}_{i , j + 1 / 2} - {q}_{i , j - 1 / 2} ) + \frac{1}{4} {β}_{i , j} ( {q}_{i + 1 , j + 1 / 2} - {q}_{i - 1 , j + 1 / 2} + {q}_{i + 1 , j - 1 / 2} - {q}_{i - 1 , j - 1 / 2} ) . & ( 46 ) \\ α = \frac{{g}^{2}}{ρ ( {ϕ}^{n + 1 / 2} ) J} ( {r}_{η}^{2} + {z}_{η}^{2} ) , β = - \frac{{g}^{2}}{ρ ( {ϕ}^{n + 1 / 2} ) J} ( {r}_{ξ} {r}_{η} + {z}_{ξ} {z}_{η} ) , \\ γ = \frac{{g}^{2}}{ρ ( {ϕ}^{n + 1 / 2} ) J} ( {r}_{ξ}^{2} + {z}_{ξ}^{2} ) . & ( 47 ) \\ {α}_{i + 1 / 2 , j + 1 / 2} = {[ \frac{{g}^{2}}{ρ ( {ϕ}^{n + 1 / 2} ) J} ( {r}_{η}^{2} + {z}_{η}^{2} ) ]}_{i + 1 / 2 , j + 1 / 2} , \\ {r}_{η ( i + 1 / 2 , j + 1 / 2 )} = \frac{1}{4} [ {r}_{η ( i + 1 , j + 1 )} + {r}_{η ( i + 1 , j )} + {r}_{η ( i , j + 1 )} + {r}_{η ( i , j )} ] , \\ {z}_{η ( i + 1 / 2 , j + 1 / 2 )} = \frac{1}{4} [ {z}_{η ( i + 1 , j + 1 )} + {z}_{η ( i + 1 , j )} + {z}_{η ( i , j + 1 )} + {z}_{η ( i , j )} ] , \\ {J}_{i + 1 / 2 , j + 1 / 2} = \frac{1}{4} [ {J}_{i + 1 , j + 1} + {J}_{i + 1 , j} + {J}_{i , j + 1} + {J}_{i , j} ] . & ( 48 ) \\ {q}_{i , j - 1 / 2} = δ {tp}^{BC} & ( 49 ) \\ \frac{1}{16} \{ {r}_{i + 1 / 2 , j + 1 / 2} [ - ( {u}_{i + 1 , j + 1} + {u}_{i , j + 1} + {u}_{i + 1 , j} + {u}_{i , j} ) ( {z}_{ξ ( i + 1 , j + 1 )} + {z}_{ξ ( i , j + 1 )} + {z}_{ξ ( i + 1 , j )} + {z}_{ξ ( i , j )} ) + ( {v}_{i + 1 , j + 1} + {v}_{i , j + 1} + {v}_{i + 1 , j} + {v}_{i , j} ) ( {r}_{ξ ( i + 1 , j + 1 )} + {r}_{ξ ( i , j + 1 )} + {r}_{ξ ( i + 1 , j )} + {r}_{ξ ( i , j )} ) ] + {r}_{i + 1 / 2 , j - 1 / 2} [ ( {u}_{i + 1 , j - 1} + {u}_{i , j - 1} + {u}_{i + 1 , j} + {u}_{i , j} ) ( {z}_{ξ ( i + 1 , j )} + {z}_{ξ ( i , j )} + {z}_{ξ ( i + 1 , j - 1 )} + {z}_{ξ ( i , j - 1 )} ) - ( {v}_{i + 1 , j - 1} + {v}_{i , j - 1} + {v}_{i + 1 , j} + {v}_{i , j} ) ( {r}_{ξ ( i + 1 , j )} + {r}_{ξ ( i , j )} + {r}_{ξ ( i + 1 , j - 1 )} + {r}_{ξ ( i , j - 1 )} ) ] \} + {r}_{i + 1 , j} ( {u}_{i + 1 , j} {z}_{η ( i + 1 , j )} - {v}_{i + 1 , j} {r}_{η ( i + 1 , j )} ) - {r}_{i + 1 , j} ( {u}_{i + 1 , j} {z}_{η ( i + 1 , j )} - {v}_{i + 1 , j} {r}_{η ( i + 1 , j )} ) - {r}_{i , j} ( {u}_{i , j} {z}_{η ( i , j )} - {v}_{i , j} {r}_{η ( i , j )} ) , & ( 50 ) \\ {α}_{i + 1 , j} ( {q}_{i + 3 / 2 , j} - {q}_{i + 1 / 2 , j} ) + \frac{1}{4} {β}_{i + 1 , j} ( {q}_{i + 3 / 2 , j + 1} - {q}_{i + 3 / 2 , j - 1} + {q}_{i + 1 / 2 , j + 1} - {q}_{i + 1 / 2 , j - 1} ) - {α}_{ij} ( {q}_{i + 1 / 2 , j} - {q}_{i - 1 / 2 , j} ) - \frac{1}{4} {β}_{i , j} ( {q}_{i + 1 / 2 , j + 1} - {q}_{i + 1 / 2 , j - 1} + {q}_{i - 1 / 2 , j + 1} - {q}_{i - 1 / 2 , j - 1} ) + {γ}_{i + 1 / 2 , j + 1 / 2} ( {q}_{i + 1 / 2 , j + 1} - {q}_{i + 1 / 2 , j} ) + \frac{1}{4} {β}_{i + 1 / 2 , j + 1 / 2} ( {q}_{i + 3 / 2 , j + 1} - {q}_{i - 1 / 2 , j + 1} + {q}_{i + 3 / 2 , j} - {q}_{i - 1 / 2 , j} ) - {γ}_{i + 1 / 2 , j - 1 / 2} ( {q}_{i + 1 / 2 , j} - {q}_{i + 1 / 2 , j - 1} ) - \frac{1}{4} {β}_{i + 1 / 2 , j - 1 / 2} ( {q}_{i + 3 / 2 , j} - {q}_{i - 1 / 2 , j} + {q}_{i + 3 / 2 , j - 1} - {q}_{i - 1 / 2 , j - 1} ) , & ( 51 ) \\ \frac{1}{4} \{ {r}_{i + 1 / 2 , j} [ ( {u}_{i + 1 , j} + {u}_{i , j} ) ( {z}_{η ( i + 1 , j )} + {z}_{η ( i , j )} ) - ( {v}_{i + 1 , j} + {v}_{i , j} ) ( {r}_{η ( i + 1 , j )} + {r}_{η ( i , j )} ) - {r}_{i - 1 / 2 , j} [ ( {u}_{i + 1 , j} + {u}_{i , j} ) ( {z}_{η ( i + 1 , j )} + {z}_{η ( i , j )} ) - ( {v}_{i + 1 , j} + {v}_{i , j} ) ( {r}_{η ( i + 1 , j )} + {r}_{η ( i , j )} ) ] - {r}_{i , j + 1 / 2} [ ( {u}_{i , j + 1} + {u}_{i , j} ) ( {z}_{ξ ( i , j + 1 )} + {z}_{ξ ( i , j )} ) - ( {v}_{i , j + 1} + {v}_{i , j} ) ( {r}_{ξ ( i , j + 1 )} + {r}_{ξ ( i , j )} ) ] + {r}_{i , j - 1 / 2} [ ( {u}_{i , j - 1} + {u}_{i , j} ) ( {z}_{ξ ( i , j - 1 )} + {z}_{ξ ( i , j )} ) - ( {v}_{i , j - 1} + {v}_{i , j} ) ( {r}_{ξ ( i , j - 1 )} + {r}_{ξ ( i , j )} ) ] \} , & ( 52 ) \\ {α}_{i + 1 / 2 , j} ( {q}_{i + 1 , j} - {q}_{i , j} ) + \frac{1}{4} {β}_{i + 1 / 2 , j} ( {q}_{i + 1 , j + 1} - {q}_{i + 1 , j - 1} + {q}_{i , j + 1} - {q}_{i , j - 1} ) - {α}_{i - 1 / 2 , j} ( {q}_{i , j} - {q}_{i - 1 , j} ) - \frac{1}{4} {β}_{i - 1 / 2 , j} ( {q}_{i - 1 , j + 1} - {q}_{i - 1 , j - 1} + {q}_{i , j + 1} - {q}_{i , j - 1} ) + {γ}_{i , j + 1 / 2} ( {q}_{i , j + 1} - {q}_{i , j} ) + \frac{1}{4} {β}_{i , j + 1 / 2} ( {q}_{i + 1 , j + 1} - {q}_{i - 1 , j + 1} + {q}_{i + 1 , j} - {q}_{i - 1 , j} ) - {γ}_{i , j - 1 / 2} ( {q}_{i , j} - {q}_{i , j - 1} ) - \frac{1}{4} {β}_{i , j - 1 / 2} ( {q}_{i + 1 , j - 1} - {q}_{i - 1 , j - 1} + {q}_{i + 1 , j} - {q}_{i - 1 , j} ) , & ( 53 ) \\ {q}_{i , j + 1 / 2}^{it + 1} = ( 1 - ω ) {q}_{i , j + 1 / 2} + \frac{ω}{{α}_{i + 1 / 2 , j + 1 / 2} + {α}_{i - 1 / 2 , j + 1 / 2} + {γ}_{i , j + 1} + {γ}_{i , j}} \{ {α}_{i + 1 / 2 , j + 1 / 2} {q}_{i + 1 , j + 1 / 2} + \frac{1}{4} {β}_{i + 1 / 2 , j + 1 / 2} ( {q}_{i + 1 , j + 3 / 2} - {q}_{i + 1 , j - 1 / 2} + {q}_{i , j + 3 / 2} - {q}_{i , j - 1 / 2} ) + {α}_{i - 1 / 2 , j + 1 / 2} {q}_{i - 1 , j + 1 / 2} - \frac{1}{4} {β}_{i - 1 / 2 , j + 1 / 2} ( {q}_{i , j + 3 / 2} - {q}_{i , j - 1 / 2} + {q}_{i - 1 , j + 3 / 2} - {q}_{i - 1 , j - 1 / 2} ) + {γ}_{i , j + 1} {q}_{i , j + 3 / 2} + \frac{1}{4} {β}_{i , j + 1} ( {q}_{i + 1 , j + 3 / 2} - {q}_{i - 1 , j + 3 / 2} + {q}_{i + 1 , j + 1 / 2} - {q}_{i - 1 , j + 1 / 2} ) - {γ}_{i , j} {q}_{i , j - 1 / 2} - \frac{1}{4} {β}_{i , j} ( {q}_{i + 1 , j + 1 / 2} - {q}_{i - 1 , j + 1 / 2} + {q}_{i + 1 , j - 1 / 2} - {q}_{i - 1 , j - 1 / 2} ) - {rhs}_{i , j + 1 / 2} \} , \\ it = 1 , … , {it}_{max} i = 1 , … , {i}_{max} j = 1 , … , {j}_{max} & ( 54 ) \\ {q}_{i , j + 1 / 2} = \frac{1}{2} ( {p}_{i , j} + {p}_{i - 1 , j} ) . & ( 55 ) \\ {ρ}_{1} = 1000 Kg \text{/} {m}^{3} , {μ}_{1} = 10 \times {10}^{- 3} Kg \text{/} m \cdot sec , σ = 0.032 Kg \text{/} {sec}^{2} , & ( 56 ) \\ Re = 4.8 , We = 9.6 . & ( 57 )\end{matrix}$$

1. A method for simulating and analyzing ejection of a first fluid from a channel, wherein there is an interface between the first fluid and a second fluid as the first fluid flows through the channel, the method comprising:
simulating the ejection of the first fluid from the channel using a level set projection algorithm comprising
(1) creating a quadrilateral grid in a physical space,
(2) calculating a transformation for transforming equations derived with respect to the quadrilateral grid for application to a uniform square grid in a computational space, the uniform square grid having a plurality of cells,
(3) solving equations governing the first and second fluids, including solving a velocity predictor equation to obtain a predictor velocity of the first fluid,
(4) projecting the predictor velocity into a divergence-free space to obtain pressure and velocity fields for the first fluid, and
(5) applying at least one divergence filter to reduce divergence at edges or centers of cells.

2. A method as recited in claim 1, wherein the first fluid is ink, the second fluid is air, and the channel is representative of an ink-jet nozzle designed to be part of a piezoelectric ink-jet head.

3. A method as recited in claim 1, wherein the transformation calculated in step (2) comprises a transformation matrix.

4. A method as recited in claim 1, wherein, in step (4), the velocity field obtained is an incompressible velocity field.

5. A method as recited in claim 1, wherein the at least one divergence filter comprises an edge filter applied at cell edges or a center filter applied at cell centers.

6. A method as recited in claim 5, wherein the at least one divergence filter comprises two edge filters including a first edge filter applied at mid-points of each cell edge of a first orientation, and a second edge filter applied at mid-points of each cell edge of a second orientation.

7. A method as recited in claim 1, further comprising an iterative linear solver to solve linear systems resulting from application of the at least one divergence filter.

8. A method as recited in claim 7, wherein 3 or less iterations are performed by the iterative linear solver to solve the linear systems.

9. An apparatus for simulating and analyzing ejection of a first fluid from a channel, wherein there is an interface between the first fluid and a second fluid as the first fluid flows through the channel, the apparatus comprising:
modules for simulating the ejection of the first fluid from the channel using a level set projection algorithm that includes modules configured to
create a quadrilateral grid in a physical space,
calculate a transformation for transforming equations derived with respect to the quadrilateral grid for application to a uniform square grid in a computational space, the uniform square grid having a plurality of cells,
solve equations governing the first and second fluids, including solving a velocity predictor equation to obtain a predictor velocity of the first fluid,
project the predictor velocity into a divergence-free space to obtain pressure and velocity fields for the first fluid, and
apply at least one divergence filter to reduce divergence at edges or centers of cells.

10. An apparatus as recited in claim 9, wherein the first fluid is ink, the second fluid is air, and the channel is representative of an ink-jet nozzle designed to be part of a piezoelectric ink-jet head.

11. An apparatus as recited in claim 9, wherein the calculated transformation comprises a transformation matrix.

12. An apparatus as recited in claim 9, wherein the obtained velocity field-is an incompressible velocity field.

13. An apparatus as recited in claim 9, wherein the at least one divergence filter comprises an edge filter applied at cell edges or a center filter applied at cell centers.

14. An apparatus as recited in claim 13, wherein the at least one divergence filter comprises two edge filters including a first edge filter applied at mid-points of each cell edge of a first orientation, and a second edge filter applied at mid-points of each cell edge of a second orientation.

15. An apparatus as recited in claim 9, further comprising an iterative linear solver to solve linear systems resulting from application of the at least one divergence filter.

16. An apparatus as recited in claim 15, wherein 3 or less iterations are performed by the iterative linear solver to solve the linear systems.

17. An apparatus as recited in claim 9, wherein the simulating module comprises a program of-instructions embodied in software, hardware, or combination thereof.

18. An apparatus as recited in claim 9, wherein the simulating module comprises a display for visually observing the simulation.

19. A machine-readable medium having a program of instructions for directing a machine to perform a method for simulating and analyzing ejection of a first fluid from a channel, wherein there is an interface between the first fluid and a second fluid as the first fluid flows through the channel, the program of instructions comprising:
instructions for simulating the ejection of the first fluid from the channel using a level set projection algorithm comprising
(1) instructions for creating a quadrilateral grid in a physical space,
(2) instructions for calculating a transformation for transforming equations derived with respect to the quadrilateral grid for application to a uniform square grid in a computational space, the uniform square grid having a plurality of cells,
(3) instructions for solving equations governing the first and second fluids, including solving a velocity predictor equation to obtain a predictor velocity of the first fluid,
(4) instructions for projecting the predictor velocity into a divergence-free space to obtain pressure and velocity fields for the first fluid, and
(5) instructions for applying at least one divergence filter to reduce divergence at edges or centers of cells.

20. A machine-readable medium as recited in claim 19, wherein the first fluid is ink, the second fluid is air, and the channel is representative of an ink-jet nozzle designed to be part of a piezoelectric ink-jet head.

21. A machine-readable medium as recited in claim 19, wherein the transformation calculated by instruction (2) comprises a transformation matrix.

22. A machine-readable medium as recited in claim 19, wherein, in instruction (4), the velocity field obtained is an incompressible velocity field.

23. A machine-readable medium as recited in claim 19, wherein the at least one divergence filter comprises an edge filter applied at cell edges or a center filter applied at cell centers.

24. A machine-readable medium as recited in claim 23, wherein the at least one divergence filter comprises two edge filters including a first edge filter applied at mid-points of each cell edge of a first orientation, and a second edge filter applied at mid-points of each cell edge of a second orientation.

25. A machine-readable medium as recited in claim 19, further comprising instructions for iteratively solving linear systems resulting from application of the at least one divergence filter.

26. A machine-readable medium as recited in claim 25, wherein the iterations for the iteratively solving instructions is set at 3 or less.
